(19) United States
(12) Patent Application Publication
(10) Pub. No.: US 2025/0282214 A1
(43) Pub. Date: Sep. 11, 2025

(54) AUTONOMOUS AGRICULTURAL VEHICLE COMPRISING A HYDROGEN-POWERED MAIN PROPULSION SYSTEM

(71) Applicant: EXEL INDUSTRIES, EPERNAY (FR)

(72) Inventors: Frederic CHAILLOU, CARQUEFOU (FR); Yannick LANGLAIS, VERTOU (FR); Camille ENDERLEN, MANSPACH (FR)

(73) Assignee: EXEL INDUSTRIES, EPERNAY (FR)

(21) Appl. No.: 18/857,387

(22) PCT Filed: Apr. 18, 2023
(86) PCT No.: PCT/EP2023/059965

§ 371 Date: Oct. 16, 2024

(30) Foreign Application Priority Data
Apr. 26, 2022 (FR) FR2203854

(51) Int. Cl. B60K 15/07; A01B 51/02; A01M 7/00; B60K 15/03; B60K 15/063

(52) U.S. Cl. CPC B60K 15/07; A01B 51/023; A01M 7/0014; A01M 7/0085; B60K 2015/03118; B60K 2015/03315; B60K 2015/0639; B60Y 2200/22

(57) ABSTRACT

The present invention relates to an autonomous agricultural vehicle (1) comprising a framework (2) and wheels (3), the framework (2) having a width, two flanks, one on each side of a longitudinal axis (X) of the autonomous agricultural vehicle (1), and a top, at least one tool being able to be housed in a working volume (20) defined by the width and the top of the framework (2), the autonomous agricultural vehicle (1) moreover comprising a hydrogen-powered propulsion system comprising at least one hydrogen fuel cell (100). The autonomous agricultural vehicle according to the invention moreover comprises at least one hydrogen cylinder (11,12) positioned longitudinally on the top of the framework (2), the hydrogen fuel cell (100) being configured to consume hydrogen from the at least one hydrogen cylinder (11, 12) and oxygen captured from the air so as to supply electrical power to an electric motor of the hydrogen-powered propulsion system.

### TECHNICAL FIELD

The present invention relates to the field of agricultural vehicles, in particular autonomous agricultural robots. More specifically, the present invention is aimed at an autonomous agricultural vehicle comprising a hydrogen-powered propulsion system.

### BACKGROUND

In the field of agricultural vehicles, autonomous vehicles have been developed. These autonomous agricultural vehicles, also referred to as agricultural robots, are adapted to work fully or partially autonomously on field crops, such as vineyards.

These autonomous agricultural vehicles have no driver on board. For example, such autonomous agricultural vehicles may carry one or more tools intended to work the soil, maintain the soil or maintain vines, such as one or more tools for trimming vines, or one or more tanks containing active products for delivery to crops, such as vineyards. Such autonomous agricultural vehicles, less bulky than agricultural vehicles with a driver, if only because it does not comprise a driver's cab or systems intended to protect or improve the driver comfort (air conditioning, cab air filter, etc.), and is particularly suited to work in narrow vineyard plots.

Today, the autonomous agricultural vehicles have electric propulsion systems supplied by high-voltage batteries or combustion engines.

For example, the document IN 202141057703 A describes a remote-controlled agricultural vehicle suitable for spraying crops. The aim here is to protect the farmer from the possible toxicity of the active products sprayed. To this end, the farmer is disembarked and controls the agricultural vehicle remotely.

The agricultural vehicle remotely controlled described in the document IN 202141057703 A comprises an electric propulsion system based on the use of lithium-ion batteries arranged on top of the vehicle on either side of an active product tank.

The present invention concerns an autonomous agricultural vehicle having a hydrogen-powered propulsion system. The hydrogen-powered propulsion systems comprise at least one electric motor supplied with energy, in particular electrical energy, by at least one hydrogen fuel cell whose function is to produce electrical energy from hydrogen and oxygen, the hydrogen being stored in tanks also referred to as cylinders and the oxygen being conventionally captured from the surrounding outside air. It should be noted that, in the context of the present invention, “hydrogen” is usually understood to mean the chemical compound with the molecular formula H₂, also referred to as dihydrogen, particularly in gaseous form; similarly, “oxygen” is understood to mean the chemical compound with the molecular formula O₂, also referred to as dioxygen, particularly in gaseous form, present in the outside air.

As is well known, the hydrogen-powered propulsion systems therefore require the presence of at least one hydrogen cylinder particularly in gaseous form. Such tanks are heavy and bulky.

In this context, the present invention is aimed at an autonomous agricultural vehicle comprising a hydrogen-powered propulsion system, with hydrogen cylinders arranged on top of the framework of the vehicle. It should be noted that it is a priori counterintuitive for the person skilled in the art to place such hydrogen cylinders on the top of the vehicle, as he would assume that, to improve the stability, it would be more appropriate to place the cylinders on the flanks.

### SUMMARY OF THE INVENTION

More precisely, the invention relates to an autonomous agricultural vehicle comprising a framework, wheels, the framework having a width, two flanks on either side of a longitudinal axis of the autonomous agricultural vehicle and a top, at least one tool being able to be accommodated in a useful volume defined by the width and the top of the framework, the autonomous agricultural vehicle further comprising a hydrogen-powered propulsion system comprising at least one hydrogen fuel cell. The autonomous agricultural vehicle according to the invention is remarkable at least in that it comprises at least one hydrogen cylinder arranged longitudinally on top of the framework, the hydrogen fuel cell being configured to consume hydrogen from the at least one hydrogen cylinder and oxygen captured from the air so as to supply electrical energy to an electric motor of the hydrogen-powered propulsion system.

The autonomous agricultural vehicle with hydrogen-powered propulsion system is therefore safer. In addition, the invention allows hydrogen cylinders of different sizes to be implemented.

In particular, the at least one hydrogen cylinders is arranged longitudinally on top of the framework.

In addition, the framework comprises two transverse beams attached to two longitudinal beams, with the at least one hydrogen cylinder resting by its ends and being attached to the two transverse beams.

In one embodiment, the autonomous agricultural vehicle comprises two hydrogen cylinders arranged longitudinally on the top of the framework, parallel to each other on either side of the longitudinal axis of the autonomous agricultural vehicle.

Advantageously, the distance between the two transverse beams, along the longitudinal axis, is adjustable,

In one embodiment, the hydrogen fuel cell supplies a power architecture comprising, in addition to the electric motor, a plurality of other items of electrical equipment. In particular, the hydrogen fuel cell may also supply electrical energy to one or more items of electrical equipment on the autonomous agricultural vehicle, including: one or more electrical power converters; one or more batteries; one or more computers.

According to one embodiment, the autonomous agricultural vehicle according to the invention comprises at least one battery, in particular a lithium-ion battery, arranged on one flank of the framework and attached to the latter.

According to an embodiment, the autonomous agricultural vehicle according to the invention comprises at least one air filter adapted to extract oxygen from the air and at least one computer arranged on a flank of the autonomous agricultural vehicle, and being configured to control the admission of hydrogen from the at least one hydrogen cylinder and oxygen, obtained by means of the air filter, in the at least one hydrogen fuel cell, to produce a quantity of electrical energy powering the electric motor of the hydrogen-powered propulsion system.

According to one embodiment, the autonomous agricultural vehicle according to the invention comprises at least one tank configured to comprise an active product and means for spraying the active product arranged in the useful volume, substantially in a longitudinal median plane of the autonomous agricultural vehicle.

According to one embodiment, the autonomous agricultural vehicle according to the invention also comprises containment panels arranged on the flanks of the autonomous agricultural vehicle and configured to block the diffusion of active product to the outside of the useful volume.

According to one embodiment, the autonomous agricultural vehicle according to the invention also comprises one or more tools intended to work the soil, maintain the soil or maintain the vines, for example one or more tools for trimming vines.

### BRIEF DESCRIPTION OF THE DRAWINGS

The invention will be better understood on reading the following description, which is given by way of example only, with reference to the accompanying drawings, which are non-limiting examples wherein identical references are given to similar objects and wherein:

FIG. 1 is a schematic front view of an autonomous agricultural vehicle comprising a hydrogen-powered propulsion system;

FIG. 2 is a schematic representation of another example of an autonomous agricultural

vehicle according to the invention, in isometric view;

FIG. 3 corresponds to an isometric view of the autonomous agricultural vehicle in [FIG. 2], showing the flank opposite to the one visible in [FIG. 2],

It should be noted that the figures set out the invention in detail to allow the invention to be implemented; although non-limiting, said figures serve in particular to better define the invention where appropriate.

### DETAILED DESCRIPTION OF THE INVENTION

The invention relates to an autonomous agricultural vehicle 1 comprising a hydrogen-powered main propulsion system.

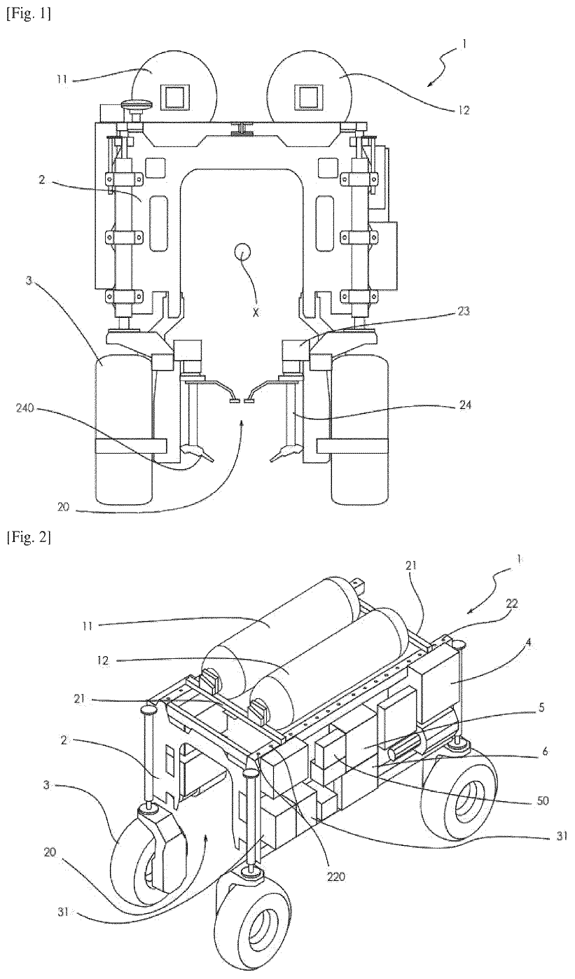

In particular, as shown in [FIG. 1], such an autonomous agricultural vehicle 1 may consist of a vineyard robot configured to carry out the treatment of a row of vineyard spanned by the body of the vineyard robot.

The treatment may consist of working the soil, soil maintenance, trimming or spraying an active product, in particular in a manner referred as confined manner.

The autonomous agricultural vehicle 1 according to the invention is equipped with a hydrogen-powered propulsion system.

With reference to [FIG. 1], the autonomous agricultural vehicle 1 according to the invention comprises a framework 2. In particular, the framework 2 defines a substantially parallelepipedal useful volume 20 with a frame, in particular a metal frame, having two flanks which rest, via suspensions, on two pairs of independent wheels. In the useful volume 20 defined by the width between the wheels 3 on either side of a longitudinal axis X of the autonomous agricultural vehicle 1 and a corresponding upper plane above the framework 2, a tool may be installed.

For example, in [FIG. 1], a tool for working the soil is installed. A tool holder 23 is installed in the useful volume. A soil-working tool 24 is attached to this tool holder 23, the soil-working tool 24 comprising blades 240 intended to penetrate the soil to work it.

In particular, the hydrogen-powered electric propulsion system of the autonomous agricultural vehicle 1 is connected to at least one hydrogen cylinder 11, 12 forming a hydrogen gas tank. Preferably, the autonomous agricultural vehicle 1 according to the invention has two hydrogen cylinders 11, 12, as in the example shown in FIGS. 1 to 3.

For example, the electric propulsion system comprises an electric motor supplied with electrical energy by at least one hydrogen fuel cell 100 drawing hydrogen fuel from hydrogen cylinders 11, 12, and oxygen from the air via an air filter 101. The hydrogen fuel cell 100 may be seen in [FIG. 3]. Below the latter is provided an exhaust device 102 for the hydrogen fuel cell 100, as shown in [FIG. 3].

In addition to the electric motor, the hydrogen fuel cell 100 may also supply electrical energy to other electrical items of equipment on the autonomous agricultural vehicle 1, forming, with the electric motor, a power architecture of the autonomous agricultural vehicle 1. Among the electrical items of equipment that may be supplied with electrical energy by the hydrogen fuel cell 100 may comprise one or more electrical power converters, one or more batteries or one or more computers, for example.

According to the invention, the hydrogen cylinders 11, 12 are arranged on top of the framework 2, and not on the flanks. In particular, the hydrogen cylinders 11, 12 are supported by the framework 2 comprising transverse 21 and/or longitudinal 22 beams, or even beams (not shown) orthogonal to the longitudinal axis X of the framework 2.

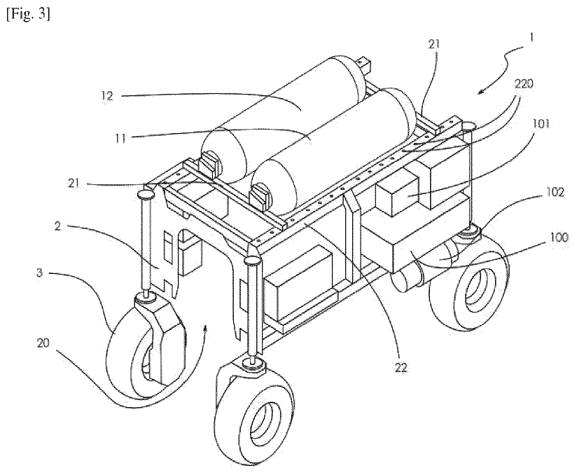

By positioning the hydrogen cylinders 11, 12 on top of the framework 2, the invention ensures that hydrogen cylinders 11, 12 of different sizes, in particular longer than those shown in [FIG. 2] or [FIG. 3], may be used without affecting the shape or the structure of the framework 2. The hydrogen cylinders 11, 12 may be supported by the framework 2, while at the same time “protruding” more or less on either side. In addition, placing the hydrogen cylinders on the flanks would have the disadvantage of limiting the diameter of the hydrogen cylinders more restrictively, with the risk of making the overall dimension more important laterally, which could be prohibitive when the autonomous agricultural vehicle is used in vineyards, as the spacing between the rows of vines is limited. The positioning of the hydrogen cylinders 11, 12 on top of the framework 2, in accordance with the invention, allows to avoid this potential disadvantage.

More precisely, with reference to [FIG. 2] and [FIG. 3], the hydrogen cylinders 11, 12 rest directly on the transverse beams 21 to which they are attached at their ends. The transverse beams 21 rest on the longitudinal beams 22, to which they are attached. According to the invention, there is therefore no mechanical contact between the hydrogen cylinders 11, 12 and the longitudinal beams 22. In this example, shown throughout the figures, the hydrogen cylinders 11, 12 are arranged longitudinally and rest on transverse beams 21 which are attached to longitudinal beams 21. However, a corresponding arrangement, not shown, consists in arranging the hydrogen cylinders on top of the framework 2, transversely. In this case, they rest in a similar way on longitudinal beams which are attached to transverse beams. All that is described below with reference to FIGS. 1 to 3, concerning the longitudinal arrangement of the hydrogen cylinders 11, 12 and the characteristics of the longitudinal beams 21 supporting transverse beams 22, applies mutatis mutandis to the case where hydrogen cylinders are arranged transversely and where transverse beams support longitudinal beams to which said hydrogen cylinders are attached.

According to the preferred embodiment shown, the distance, along the longitudinal axis X of the framework 2, between the transverse beams 21, is adjustable. In this way, the distance between the transverse beams 21 at the front and rear of the framework 2 may be adapted to different lengths of hydrogen cylinders 11, 12. For example, one or other of the transverse beams 21, or both transverse beams 21, are configured to be translatable on the longitudinal beams 22, along the direction of the longitudinal axis X, in order to be attached to the longitudinal beams 22. It results in that, depending on the location chosen to attach the transverse beams 21, the latter may be at different distances from each other. To this end, opposing holes 220 may be provided at different levels on the longitudinal beams 22, the holes 220 being intended to receive attachment screws for attaching the transverse beams 21 to the longitudinal beams 22. Rather than hole 220/screw pairs, other attachment means may be pre-positioned at different levels on the longitudinal beams 22, such as rectangular openings into which lugs provided on the transverse beams 21 may be clipped.

This additional advantage is also due to the fact that the hydrogen cylinders 11, 12 are arranged on top of the framework 2. The framework 2 is made of metal, such as steel. Its shape and its volumes are configured so as not to create a cavity likely to receive and store hydrogen escaping from the hydrogen cylinders 11, 12.

In this arrangement, the hydrogen cylinders 11, 12 are securely arranged. In the event of an overturn on one flank of the autonomous agricultural vehicle 1, for example due to uneven terrain or a particular topology (slope), the hydrogen cylinders 11,12 are spared and do not risk damage. Above all, in the event of an overturn on one flank we avoid trapping a damaged hydrogen cylinder, from which hydrogen would escape, under the framework and under the agricultural vehicle which could lead to the creation of pockets of pressurized, confined hydrogen, creating a major hazard. Hydrogen is a light, highly volatile gas. So in the event of a leak, the general behavior of the hydrogen will be to move upwards. With the hydrogen cylinders 11, 12 on top, even if the autonomous agricultural vehicle 1 tips over on one flank there are no obstacles to block the escape of hydrogen.

The connectors connecting the hydrogen cylinders 11, 12 to the hydrogen fuel cell 100 via pipes are preferably also arranged mainly on the top of the framework 2 and are therefore securely arranged, as the connectors are not liable to damage in the event of the autonomous agricultural vehicle 1 tipping over onto its flank.

The risk of damage to the hydrogen cylinders 11,12 in the event of the autonomous agricultural vehicle 1 tipping over on one flank is thus greatly reduced, and the escape of hydrogen in the event of the autonomous agricultural vehicle 1 tipping over on one flank is not impeded. The safety of use of the autonomous agricultural vehicle 1 equipped with a hydrogen-powered propulsion system is therefore improved. It should be noted that this advantage also applies when the vehicle is not overturned: for example, in the event of a hydrogen leak at the level of the cylinders 11, 12 or at the level of the pipe between the cylinders 11, 12 and the hydrogen fuel cell 100, or on connections between the cylinders 11, 12 and said pipes, the hydrogen may easily escape upwards.

Another advantage of the arrangement of the hydrogen cylinders 11, 12 on top is that the tool located in the useful volume 20 is easily accessible. In particular, according to one embodiment, the autonomous agricultural vehicle 1 performs a spraying function. In this case, the spraying tunnel corresponds to the useful volume 20, between the pairs of wheels 3 and the top of the framework 2, and containment walls are advantageously arranged on the flanks. It should be noted that this contained spraying function would not be possible if the hydrogen cylinders 11,12 were arranged on the flanks as there would be no possibility of placing containment panels on the flanks, since the latter would be occupied by hydrogen cylinders.

The same applies when the autonomous agricultural vehicle 1 performs a trimming function: the trimming tool also requires space on the flanks of the vehicle.

In one embodiment, one or more lithium-ion batteries 31 may be arranged on the flanks of the autonomous agricultural vehicle 1 to supply power to the vehicle's auxiliary electrical systems and/or to provide an additional energy to the autonomous agricultural vehicle 1, in particular to the propulsion system, in the event of a power peak required to operate the vehicle.

A computer 5 coupled to a controller 6 may also be arranged, in particular close to the controller 6, on a flank of the autonomous agricultural vehicle 1, to control the autonomous agricultural vehicle 1.

A hydrogen fuel cell 100 management computer 50 is dedicated to control the hydrogen fuel cell 100. In particular, the hydrogen fuel cell 100 management computer 50 manages the electricity production, depending on the power requirements of the autonomous agricultural vehicle 1. Another computer, for example, may manage the supply of hydrogen from the hydrogen cylinders 11, 12 and oxygen captured from the air to the hydrogen fuel cell 100.

Below the hydrogen fuel cell 100, an exhaust 102 is configured to evacuate the water produced during the production of electricity from hydrogen and oxygen. The autonomous agricultural vehicle 1, as shown in [FIG. 2], may also have an oil tank 4 which may be arranged on one flank of the vehicle, the oil being intended to be used in the autonomous agricultural vehicle 1 and its tools.

1-8. (canceled)

9. An autonomous agricultural vehicle comprising a framework, wheels, the framework having a width, two flanks on either side of a longitudinal axis of the autonomous agricultural vehicle, and a top, at least one tool being able to be accommodated in a useful volume defined by the width and the top of the framework, the autonomous agricultural vehicle further comprising a hydrogen-powered propulsion system comprising at least one hydrogen fuel cell, wherein said autonomous agricultural vehicle further comprises at least one hydrogen cylinder arranged longitudinally on top of the framework, the framework further comprising two transverse beams attached to two longitudinal beams, the at least one hydrogen cylinder resting by its ends and being attached to the two transverse beams, the hydrogen fuel cell being configured to consume hydrogen from the at least one hydrogen cylinder and oxygen captured from the air, so as to supply electrical energy to an electric motor of the hydrogen-powered propulsion system.

10. The autonomous agricultural vehicle according to claim 9, comprising two hydrogen cylinders arranged longitudinally on the top of the framework parallel to each other, on either side of the longitudinal axis of the autonomous agricultural vehicle.

11. The autonomous agricultural vehicle according to claim 10, wherein the distance between the two transverse beams, along the longitudinal axis, is adjustable.

12. The autonomous agricultural vehicle according to claim 9, wherein the hydrogen fuel cell also supplies electrical energy to one or more items of electrical equipment on the autonomous agricultural vehicle, including: one or more electrical power converters; one or more batteries; one or more computers.

13. The autonomous agricultural vehicle according to claim 9, comprising at least one battery, in particular a lithium-ion battery, arranged on one flank of the framework and attached to the latter.

14. The autonomous agricultural vehicle according to claim 9, comprising at least one air filter adapted to filter air and at least one computer arranged on a flank of the autonomous agricultural vehicle, and being configured to control the admission of hydrogen from the at least one hydrogen cylinder and oxygen obtained by means of the air filter, in the at least one hydrogen fuel cell, to produce a quantity of electrical energy powering the electric motor of the hydrogen-powered propulsion system.

15. The autonomous agricultural vehicle according to claim 9, comprising at least one tank configured to comprise an active product and means for spraying the active product arranged in the useful volume, substantially in a longitudinal median plane of the autonomous agricultural vehicle.

16. The autonomous agricultural vehicle according to claim 15, comprising containment panels arranged on the flanks of the autonomous agricultural vehicle and configured to block the diffusion of active product to the outside of the useful volume.
